(19) United States
(12) Patent Application Publication
(10) Pub. No.: US 2026/0196759 A1
(43) Pub. Date: Jul. 9, 2026

(54) Multi-Contact Terminal

(71) Applicant: Tyco Electronics AMP Korea Co., Ltd., Gyeongsan (KR)

(72) Inventors: Byung-Hee Cho, Gyeongsan-Si (KR); Sung-Chul Kim, Gyeongsan-Si (KR); Suk-Eun Jung, Gyeongsan-Si (KR); Ki Deok Cheon, Gyeongsan-Si (KR)

(73) Assignee: Tyco Electronics AMP Korea Co., Ltd., Gyeongsan (KR)

(21) Appl. No.: 19/444,626

(22) Filed: Jan. 9, 2026

(30) Foreign Application Priority Data
Jan. 9, 2025 (KR) 10-2025-0003436
Jan. 9, 2025 (KR) 30-2025-0001197
Dec. 31, 2025 (KR) 10-2025-0215940

(51) Int. Cl. H01R 13/11; H01R 12/70

(52) U.S. Cl. CPC H01R 13/112; H01R 12/707; H01R 13/113

(57) ABSTRACT

A multi-contact terminal has a body portion, a first contact row, a second contact row and a soldering tail. The body portion includes a pair of a first body plate and a second body plate having shapes corresponding to each other. The first contact row is formed at one edge of each of the first body plate and the second body plate, and includes a plurality of first contact beams arranged side by side. The second contact row is formed in a surface of each of the first body plate and the second body plate, and includes a plurality of second contact beams arranged side by side. The soldering tail is formed on another edge of each of the first body plate and the second body plate, and is soldered to a printed circuit board (PCB).

### CROSS-REFERENCE TO RELATED APPLICATION

This application claims the benefit of Korean Patent Application Nos. 10-2025-0003436 and 30-2025-0001197, each filed on Jan. 9, 2025, and Korean Patent Application No. 10-2025-0215940, filed on Dec. 31, 2025, in the Korean Intellectual Property Office, the entire disclosures of which are incorporated herein by reference for all purposes.

### FIELD OF THE INVENTION

The disclosure relates to a terminal having multiple contacts.

### BACKGROUND OF THE INVENTION

Various types of electrical connectors are used in the electrical field. In some cases, connectors are used to connect a high-voltage range and/or a high-current range system. Hereinafter, a connector that connects high voltage and/or high current is referred to as a high-current connector, and the term “high current” is intended to include “high voltage.” A terminal for applying high current requires a large number of contacts to apply high current. However, as the number of contacts increases, the size of the terminal increases proportionally.

### SUMMARY OF THE INVENTION

According to an embodiment of the present disclosure, a multi-contact terminal has a body portion, a first contact row, a second contact row and a soldering tail. The body portion includes a pair of a first body plate and a second body plate having shapes corresponding to each other. The first contact row is formed at one edge of each of the first body plate and the second body plate, and includes a plurality of first contact beams arranged side by side. The second contact row is formed in a surface of each of the first body plate and the second body plate, and includes a plurality of second contact beams arranged side by side. The soldering tail is formed on another edge of each of the first body plate and the second body plate, and is soldered to a printed circuit board (PCB).

### BRIEF DESCRIPTION OF DRAWINGS

The above and other features of the present invention will become more apparent by describing in detail exemplary embodiments thereof with reference to the accompanying drawings, in which:

FIG. 1 is a perspective view of a multi-contact terminal according to an embodiment of the present disclosure;

FIG. 2 is a front view of the multi-contact terminal of FIG. 1, viewed from a first direction; and

FIG. 3 is a perspective view illustrating a state in which a tab terminal is coupled to the multi-contact terminal of FIG. 1.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled,” or “joined” to another component, the former may be directly “connected,” “coupled,” or “joined” to the latter directly or via another component.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

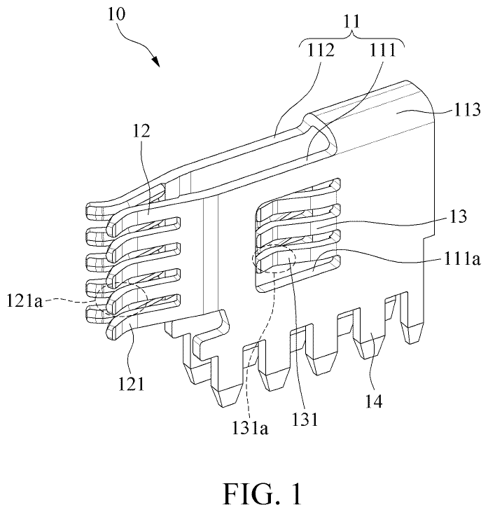

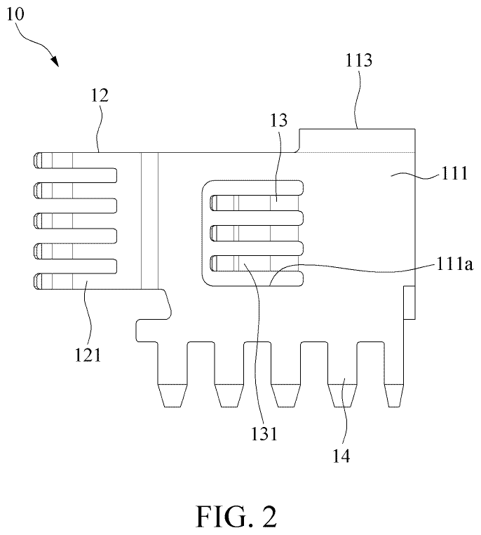

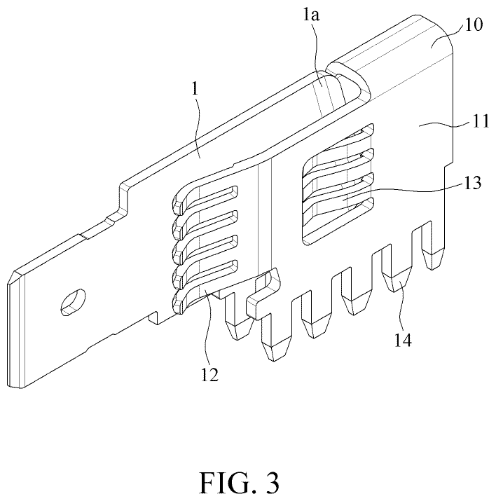

Hereinafter, a multi-contact terminal 10 according to embodiments will be described with reference to FIGS. 1 through 3. Referring to the drawings, the multi-contact terminal 10 includes a body portion 11, a plurality of contact rows 12 and 13 and a soldering tail 14. The body portion 11 includes a pair of a first body plate 111 and a second body plate 112 having shapes corresponding to each other. The first body plate 111 and the second body plate 112 are provided parallel to each other while being spaced apart from each other by a predetermined distance so as to form a space for fitting with a coupling target (hereinafter, referred to as a tab terminal 1) therein.

In addition, the first body plate 111 and the second body plate 112 are connected to each other at a connection portion 113 formed on one side of an edge of the body portion 11. That is, the first and second body plates 111 and 112 may be molded as a single member, and may be bent at the connection portion 113 to form the body portion 11. However, the connection portion 113 is merely an example for ease of description, and the position, size, and shape of the connection portion 113 are not limited by the drawings. In each of the first body plate 111 and the second body plate 112, two contact rows 12 and 13 are formed by arranging a plurality of contact beams 121 and 131. The first body plate 111 and the second body plate 112 have substantially the same shape, and thus, the first body plate 111 will be described hereinafter.

The contact rows 12 and 13 include rows of contact beams 121 and 131 formed by arranging the plurality of contact beams 121 and 131 side by side. The first contact row 12 is formed as the plurality of first contact beams 121 extend outward from one edge of the first body plate 111. The second contact row 13 is formed as a predetermined opening 111a is formed in a surface of the first body plate 111 and the plurality of second contact beams 131 extend from one edge of the opening 111a in the same direction as the first contact beams 121. The first contact row 12 and the second contact row 13 are sequentially formed along a direction in which the tab terminal 1, which will be described later, is inserted into the multi-contact terminal 10. That is, the multi-contact terminal 10 is formed to sequentially contact the first contact row 12 and the second contact row 13 when the tab terminal 1 is inserted.

Each of the first contact beams 121 and the second contact beams 131 is formed as a cantilever beam having one end fixed to the first body plate 111 and the other end as a free end. In addition, the first contact beams 121 and the second contact beams 131 are bent to be curved toward an inner space of the multi-contact terminal 10 to form contact points 121a and 131a. That is, the first contact beams 121 and the second contact beams 131 electrically contact the tab terminal 1 at the contact points 121a and 131a when the tab terminal 1 is inserted. Further, since the first contact beams 121 and the second contact beams 131 have a cantilever beam shape, the first contact beams 121 and the second contact beams 131 elastically contact the tab terminal 1 by their own elasticity, thereby stably maintaining a contact state. In addition, the first contact beams 121 and the second contact beams 131 have substantially the same shape and size. Further, a spacing between the first contact beams 121 and a spacing between the second contact beams 131 may be substantially equal to each other.

The first contact row 12 and the second contact row 13 simultaneously electrically contact the tab terminal 1 to form multiple contacts. For example, five first contact beams 121 are disposed in the first contact row 12, and three second contact beams 131 are disposed in the second contact row 13. In this way, a total of sixteen contacts with the tab terminal 1 are formed.

According to the present embodiment, the first contact beams 121 and the second contact beams 131 include contact points 121a and 131 formed in a rounded curved shape, thereby reducing the insertion force when the tab terminal 1 is inserted. Here, in the case of the multi-contact terminal the insertion force increases in proportion to the number of contacts. However, in the multi-contact terminal 10 according to the present embodiment, the tab terminal 1 is inserted while sliding along the curved surfaces of the contact points 121a and 131a when the tab terminal 1 is assembled, and thus, it is possible to prevent a rapid increase in the insertion force and reduce the insertion force. In addition, since the tab terminal 1 sequentially comes into contact with the first contact row 12 and the second contact row 13, the multi-contact terminal 10 may prevent a rapid increase in the insertion force. Further, according to the present embodiment, since the first contact row 12 and the second contact row 13 are formed, a large number of contacts may be formed without increasing the size of a single multi-contact terminal 10.

The soldering tail 14 is formed at one edge of the first body plate 111, and is formed to be divided into a plurality of portions. In addition, the soldering tail 14 is formed at an edge on which the first contact row 12 is not formed. According to the present embodiment, by forming a plurality of soldering tails 14, the multi-contact terminal 10 may increase the cross-sectional area of portions soldered to a printed circuit board (PCB) (not shown), thereby applying high current and simultaneously suppressing a temperature increase occurring when high current is applied.

While the embodiments have been described with reference to the limited drawings, it will be apparent to one of ordinary skill in the art that various alterations and modifications can be made from the above description. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

1. A multi-contact terminal, comprising:
a body portion including a pair of a first body plate and a second body plate having shapes corresponding to each other;
a first contact row formed at one edge of each of the first body plate and the second body plate, and including a plurality of first contact beams arranged side by side;
a second contact row formed in a surface of each of the first body plate and the second body plate, and including a plurality of second contact beams arranged side by side; and
a soldering tail formed on another edge of each of the first body plate and the second body plate.

2. The multi-contact terminal of claim 1, wherein the first contact row and the second contact row are adapted to sequentially contact a coupling target with respect to a direction in which the coupling target is assembled.

3. The multi-contact terminal of claim 2, wherein the first contact beams and the second contact beams have a same size and a same shape.

4. The multi-contact terminal of claim 3, wherein the second contact row is formed at one edge of an opening formed in a surface of each of the first body plate and the second body plate.

5. The multi-contact terminal of claim 4, wherein the second contact row includes the second contact beams arranged in a same direction as the first contact beams.

6. The multi-contact terminal of claim 3, wherein a spacing between the first contact beams and a spacing between the second contact beams are equal to each other.

7. The multi-contact terminal of claim 3, wherein the second contact row comprises a number of second contact beams smaller than a number of first contact beams.

8. The multi-contact terminal of claim 3, wherein the first contact beams and the second contact beams are bent so as to curve toward an inner space of the body portion to form contact rows to be electrically connected to the coupling target.

9. The multi-contact terminal of claim 1, wherein the soldering tail is adapted to be divided into a plurality of portions.

10. The multi-contact terminal of claim 9, wherein the soldering tail is formed at an edge on which the first contact row is not formed.

11. The multi-contact terminal of claim 1, wherein the soldering tail is soldered to a printed circuit board (PCB).

12. A multi-contact terminal, comprising:
a body portion including a corresponding pair of a first body plate and a second body plate;
a first contact row formed at one edge of each of the first body plate and the second body plate, and including a plurality of first contact beams arranged side by side;
a second contact row formed in a surface of each of the first body plate and the second body plate, and including a plurality of second contact beams arranged side by side; and
a soldering tail formed on another edge of each of the first body plate and the second body plate.

13. The multi-contact terminal of claim 12, wherein the first contact beams and the second contact beams have a common size and shape.

14. The multi-contact terminal of claim 12, wherein the second contact row is formed at one edge of an opening formed in a surface of each of the first body plate and the second body plate.

15. The multi-contact terminal of claim 12, wherein the second contact row includes the second contact beams arranged in a same direction as the first contact beams.

16. The multi-contact terminal of claim 12, wherein a spacing between the first contact beams and a spacing between the second contact beams are equal to each other.

17. The multi-contact terminal of claim 12, wherein the second contact row comprises a number of second contact beams smaller than a number of first contact beams.

18. The multi-contact terminal of claim 12, wherein the first contact beams and the second contact beams are bent to be curved toward an inner space of the body portion to form contact rows to be electrically connected to the coupling target.

19. The multi-contact terminal of claim 12, wherein the soldering tail is formed at an edge on which the first contact row is not formed.

20. A multi-contact terminal assembly, comprising:
a printed circuit board (PCB); and
a contact terminal, including:
a body portion comprising a pair of a first body plate and a second body plate having shapes corresponding to each other;
a first contact row formed at one edge of each of the first body plate and the second body plate, and comprising a plurality of first contact beams arranged side by side;
a second contact row formed in a surface of each of the first body plate and the second body plate, and comprising a plurality of second contact beams arranged side by side; and
a soldering tail formed on another edge of each of the first body plate and the second body plate, and soldered to the PCB.
